(19) United States
(12) Patent Application Publication
(10) Pub. No.: US 2016/0211720 A1
(43) Pub. Date: Jul. 21, 2016

(54) BEARING ARRANGEMENT FOR AN ELECTRIC MOTOR USED FOR PROPELLING AN UNMANNED AERIAL SYSTEM

(71) Applicant: KDE Direct, LLC, Washougal, WA (US)

(72) Inventor: Patrick Koegler, Washougal, WA (US)

(21) Appl. No.: 14/601,488

(22) Filed: Jan. 21, 2015

(51) Int. Cl. H02K 7/08; B64C 39/02

(52) U.S. Cl. CPC H02K 7/083; B64C 39/024; H02K 2205/03; B64C 2201/042; B64C 2201/108

(57) ABSTRACT

A bearing arrangement for an electric motor used for propelling an unmanned aerial system. The bearing arrangement includes three bearings having rolling bearing elements, one of which has a contact angle that is nominally zero and at least one other of which has a contact angle that is nominally non-zero.

### FIELD OF THE INVENTION

The present invention relates to a bearing arrangement for an electric motor that is used for propelling an unmanned aerial vehicle or system.

### BACKGROUND

As battery technology improves, electric motors are increasingly being used in place of internal combustion engines to power unmanned aerial vehicles or systems (hereinafter “unmanned aerial system” or “UAS”).

Electric motors comprise two primary sections, a rotor and a stator. The stator, by convention, is stationary, and the rotor spins relative to the stator.

One of the rotor and stator carries one or more permanently magnetized elements (hereinafter “magnets”), while the other of the rotor and stator carries one or more coils of electrically conductive wire for carrying an electrical current and thereby generating a magnetic field according to Ampere's law. The magnetic field generated by the coils interacts with the magnetic field produced by the magnets so as to cause the rotor to turn relative to the stator.

The source of electrical current that is used to drive the coils is, like the stator, stationary. In ordinary brushed DC electrical motors, the spinning rotor carries the coils. Therefore brushes, which drag across coil contact pads on the spinning rotor, are needed to make electrical connection between the source of electrical current and the coils, to provide for commutation of the electric current. Since there is friction between the brushes and the coil contact pads, the brushes are designed to sacrificially wear out in favor of preserving the contact pads, and require periodic replacement.

Alternatively, the spinning rotor may carry the magnets, with the stator carrying the coils. In that case, the coils and the source of electrical current are both stationary so no brushes are needed for commutation and the motor is turned “brushless.” In addition to providing the advantage of greater reliability and less maintenance, the “brushless” motor generally provides for more torque and therefore greater efficiency, which is a main reason why brushless motors are preferred in applications where minimizing weight and maximizing operating longevity is important, such as in a UAS.

Brushless electric motors may be of two general types, termed “inrunner” and “outrunner.” FIG. 1 illustrates the basic architecture of an inrunner brushless motor 10, in which the rotor (12) is contained within the stator (14) as is in the ordinary, brush-type electric motor; however, in contrast to the ordinary, brush-type electric motor, the rotor carries the magnets (11), and the coils (13) are attached to the stator.

In contrast to the inrunner motor, FIG. 2 illustrates the basic architecture of an outrunner brushless motor 15, in which the rotor (16) encloses the stator (18) within an outer shell or “can” portion 16a, so that the stator is inside the rotor; the rotor still carrying the magnets (17) and the coils (19) still being attached to the stator to allow for brushless operation.

The inrunner motor produces higher spin rates than the outrunner, and commensurately, less torque. For the typical UAS application, the spin rates of the inrunner motor are too high and require gear reduction so the outrunner is generally preferred.

UAS's are increasingly being produced and employed to carry cameras, and are being developed to deliver parcels. No doubt they will be used for other purposes as well. The more they are used, the more the reliability and dependability of the motors used to power them will be important, and so it is an object of the present invention to address this need by providing a novel bearing arrangement for an electric motor that can be used in the UAS application.

### SUMMARY

A bearing arrangement for an electric motor that is used for propelling an unmanned aerial system is disclosed herein. The motor has a rotor establishing an axis of rotation thereof, and a stator. The rotor includes a shaft having an output end that extends in a first direction along the axis of rotation and an opposite end. The bearing arrangement includes first, second, and third bearings.

Each bearing includes rolling bearing elements, a first inner race, and a first outer race, where the inner race has a corresponding inner race surface and opposed outer race surface and the outer race has a corresponding inner race surface and opposed outer race surface.

In each bearing, the rolling bearing elements are disposed between and bear against respective portions of the inner race surface of the respective outer race and outer race surface of the respective inner race.

The outer race surface of the first inner race encircles and bears against a first portion of the shaft proximate the output end of the shaft and the outer race surface of the first outer race is encircled by and bears against a first portion of the stator proximate the output end of the shaft.

The outer race surface of the third inner race encircles and bears against a portion of the shaft proximate the opposite end of the shaft and the outer race surface of the third outer race is encircled by and bears against a portion of the stator proximate the opposite end of the shaft.

The outer race surface of the second inner race encircles and bears against a second portion of the shaft between the first and third bearings and the outer race surface of the second outer race is encircled by and bears against a second portion of the stator between the first and third bearings.

The first bearing has a first contact angle and the second bearing has a second contact angle, and one of the first and second contact angles is nominally zero while the other of the first and second contact angles is nominally non-zero.

The first contact angle may be nominally zero where the second contact angle is nominally non-zero.

The third bearing may have a third contact angle that is nominally non-zero, and the second and third contact angles may have opposite polarities.

The electric motor may be brushless, and more particularly, it may be an outrunner.

At least one instance of the electric motor may be included in the unmanned aerial system, and wherein a set of one or more angled blades are operably connected to the electric motor at the output end of the shaft.

At least two instances of the electric motor may be included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

The bearing arrangement may include no bearings that have rolling bearing elements other than the first, second, and third bearings.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a simplified schematic representation of a basic inrunner brushless electric motor.

FIG. 2 is a simplified schematic representation of a basic outrunner brushless electric motor.

FIG. 3 is an exploded elevation view of an outrunner brushless electric motor according to the present invention.

FIG. 4 is a perspective exploded view of a portion of the electric motor as seen in FIG. 3, showing particularly a stator thereof looking down from above.

FIG. 5 is a perspective, exploded view of a portion of the electric motor as seen in FIG. 3, showing particularly the stator thereof looking up from below.

FIG. 6 is a perspective view of a standard radial contact ball bearing.

FIG. 7 is a cross-sectional view of the ball bearing of FIG. 6, taken along a line 7-7 thereof.

FIG. 8 is a cross-section of a standard angular contact ball bearing, corresponding to the cross-section of FIG. 7.

FIG. 9 is a schematic representation of the basic outrunner brushless electric motor of FIG. 3 for comparison with the schematic representation of the basic standard outrunner motor in FIG. 2.

FIG. 10 is a perspective view of a portion of an unmanned aerial system showing two of the electric motors of FIG. 3 installed therein according to the present invention.

FIG. 11 is a schematic representation of the motor of FIG. 3 with angular contact bearings according to the invention having first respective polarities and being loaded in a first axial direction.

FIG. 12 is a schematic representation of the motor of FIG. 3 with angular contact bearings according to the invention having the respective polarities of FIG. 12 but being loaded in a second axial direction, opposite to that of FIG. 11.

FIG. 13 is a schematic representation of the motor of FIG. 3 with angular contact bearings according to the invention having second respective polarities, opposite those of FIGS. 11 and 12, while still being loaded as in FIG. 12.

FIG. 14 is a schematic representation of the motor of FIG. 3 with angular contact bearings according to the invention having the respective polarities of FIG. 13, while still being loaded as in FIG. 13.

### DETAILED DESCRIPTION OF PREFERRED EMBODIMENTS

The present invention is particularly adapted for electric motors that are used to propel UAS's, which are typically brushless and employ the aforedescribed outrunner architecture. Embodiments of the invention will therefore be shown and described herein in that particular context; however, it should be understood that the invention has more general applicability, as will become apparent.

FIG. 3 shows a motor 20 according to the present invention, adapted for use in a UAS. The motor 20 has outrunner architecture, with a rotor 22, and a stator 24. The rotor 22 has a shaft 22a, a “top cap” portion 22b and a “can” portion 22c. The rotor includes magnets (not visible) attached to the inner periphery of the can portion. The magnetic fields produced by the magnets interact with coils on the stator 24.

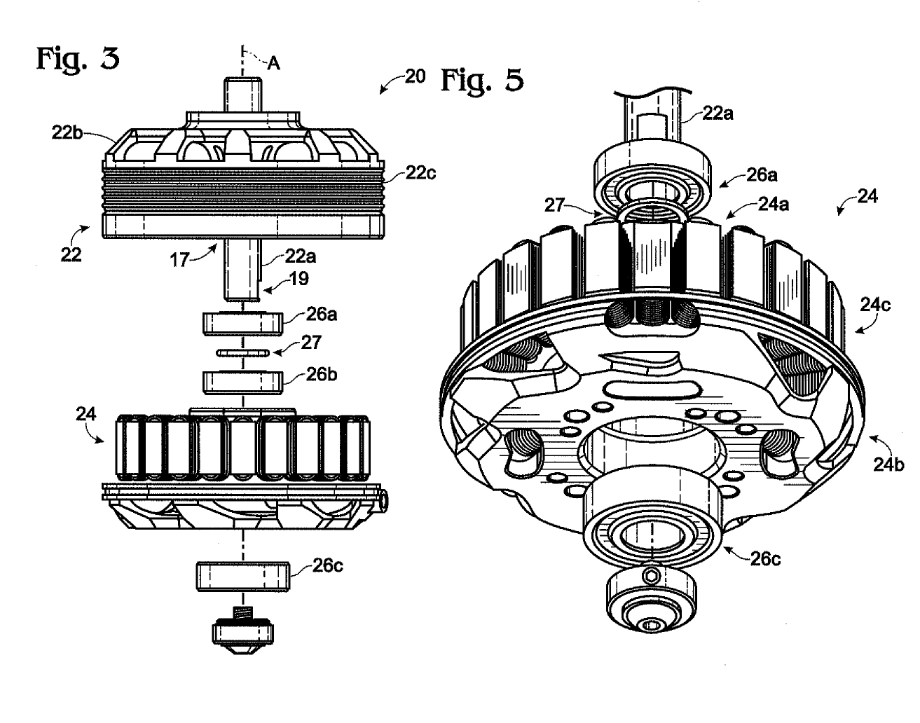

FIGS. 4 and 5 show the stator 24. FIG. 4 shows the stator looking down from above (where above is “up” in FIG. 3), and FIG. 5 shows the stator, looking up from above. The coils (29) are wound around legs 24a of the stator. The stator may have a cap portion 24b for attaching a magnetically permeable body portion 24c which is typically foamed of a ferritic material such as mild steel or silicon steel to enhance the magnetic fields produced by the coils.

As seen in FIGS. 3-5, the motor 20 may include three bearings 26a, 26b, and 26c to provide the mechanical interface between the spinning rotor and the stationary stator. The bearings 26a and 26b are provided at an output end 17 of the shaft portion 22a of the shaft, and the bearing 26c is provided at an opposite end 19 of the shaft portion.

According to the invention, the bearings 26b and 26e may be of a particular type known in the bearing art as an “angular contact” ball bearing, and the bearing 26a may be of a particular type that will be referred to herein as a “radial contact” ball bearing.

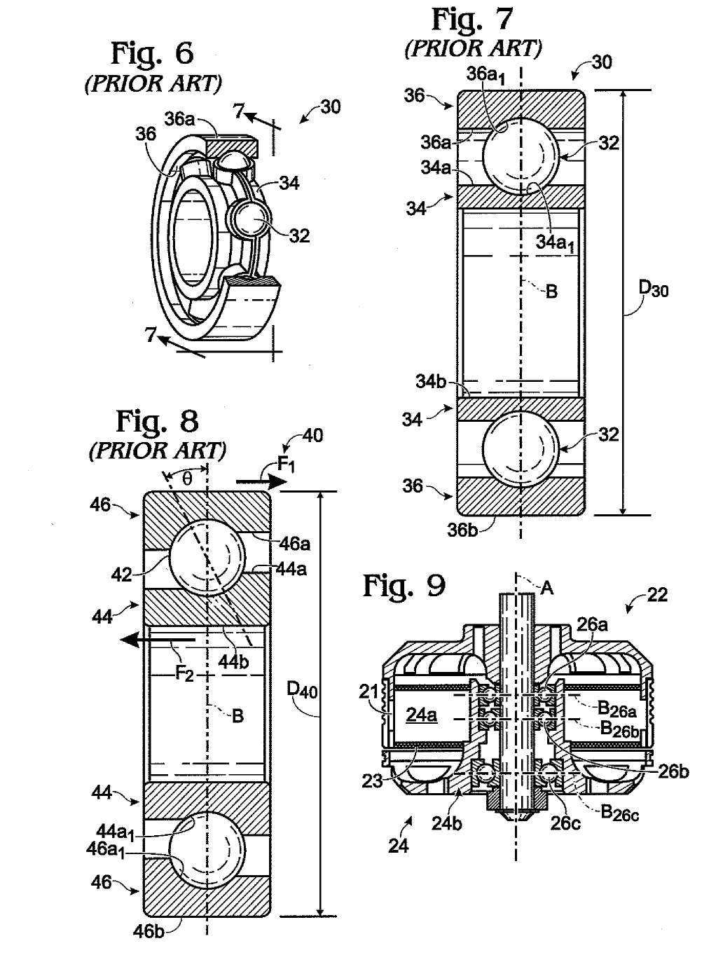

FIG. 6 shows a typical radial contact ball bearing 30 which includes a set of spherical balls 32, an inner bearing race 34, and an outer bearing race 36. The balls 32 are sandwiched between respective inner surfaces 34a, 36a of the inner and outer bearing races.

FIG. 7 shows the bearing 30 in cross-section, simplified to highlight the principle of operation of this type of bearing. The inner surfaces 34a, 36a of the inner and outer races 34 and 36 have respective concavities 34a₁ and 36a₁ for receiving and retaining the balls between the races. The concavities are shown having substantially circular cross-sections, which is typical, but they could have other shapes, for example, “V” shapes. In any case, the concavities establishing a “contact angle” between the balls and the races, which is measured relative to the bearing axis “B.”

The bearing 30 is ordinarily a standard or “off-the-shelf” part, purchased as an assembled unit, and has nominal dimensions which are subject to ordinary manufacturing tolerances. The actual contact angle of the bearing varies with loading, but in an unloaded state of the bearing, the nominal contact angle is defined by the geometry of the concavities, which in turn define a line of contact between the inner surface of the inner race, the balls, and the inner surface of the outer race, which is centered within the concavities established by the inner surfaces.

If, as in the bearing 30, the concavities are symmetrical about the bearing axis B, the contact angle is nominally zero.

The bearing 30 has a bearing diameter D₃₀, measured on the outer surface 36b of the outer bearing race 36, which also has a nominal value which is subject to ordinary manufacturing tolerances.

Where the bearing 30 is used in an electric motor, the outer surface 34b of the inner bearing race 34 bears against the rotor, and the outer surface 36b of the outer bearing race 36 bears against the stator. The inner race is able to turn independently of the outer race due to rotation of the balls therebetween.

Turning to FIG. 8, an angular contact ball bearing 40 is shown in cross-section, in a simplified form, to highlight the principle of operation of this type of bearing. Like the bearing 30, the bearing 40 is ordinarily a standard or “off-the-shelf” part, purchased as an assembled unit, and has nominal dimensions which are subject to ordinary manufacturing tolerances.

The bearing 40 includes a set of spherical balls 42, an inner bearing race 44, and an outer bearing race 46, the inner and outer bearing races having respective inner surfaces 44a and 46a, and respective concavities 44a₁ and 46a₁. As can be seen, the concavities are asymmetric, establishing a nominally non-zero contact angle θ.

The bearing 40 also has a nominal outermost bearing diameter D₄₀, which is also subject to ordinary manufacturing tolerances.

As can be appreciated by inspection of FIG. 7, a radial contact bearing can withstand some axial loading. But as can be appreciated by inspection of FIG. 8, an angular contact bearing can withstand more axial loading than a radial contact bearing, but only in one direction. In particular, if there is a force “F₁” applied to the outer race 46 and a reaction force “F₂” at the inner race 42 in the directions of the arrows, the angular contact bearing 40 will have a greater resistance to the force than a radial bearing of the same size due to the asymmetry of the concavities 44a₁ and 46a₁. On the other hand, if the directions of the forces were reversed, the bearing would tend to be drawn apart and would provide inadequate resistance to the axial loading.

Where the bearing 40 is used in an electric motor, an outer surface 44b of the inner bearing race 44 bears against the rotor, and an outer surface 46b of the outer bearing race 46 bears against the stator. The inner race is able to turn independently of the outer race due to rotation of the balls therebetween.

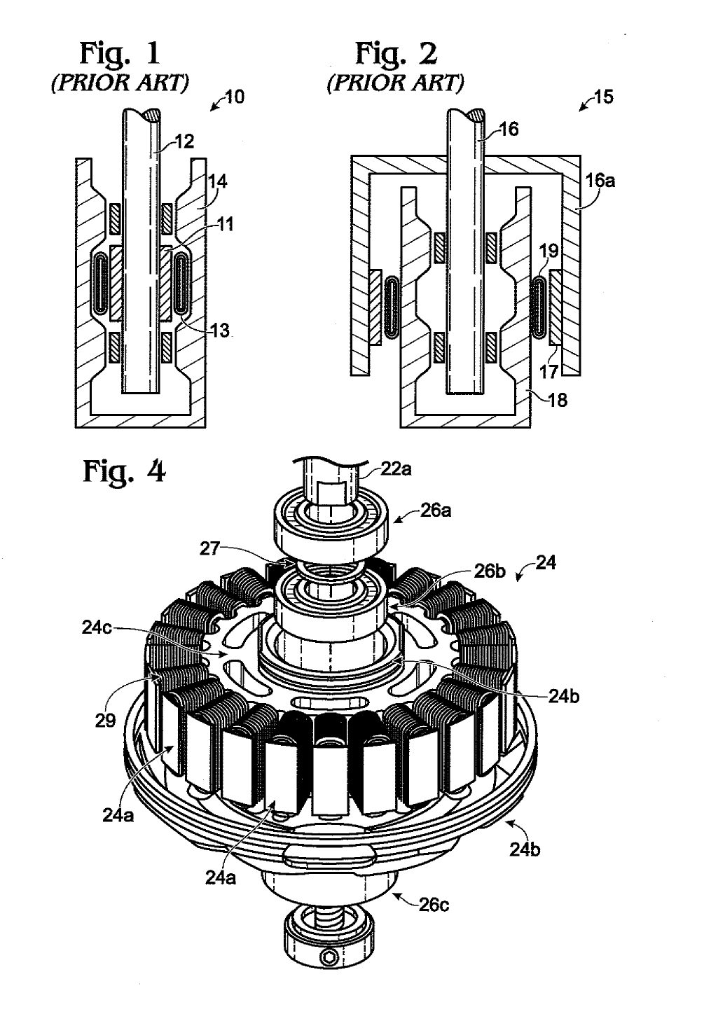

FIG. 9 shows a simplified representation of the motor 30 for comparison with FIG. 2, including showing the magnets (21) and coils (23). The rotor spins about an axis of revolution “A,” and the bearings each have a bearing axis “B ”extending radially from the axis A, namely, “B₂₆ₐ” for the bearing 26a, “B_{26b}”for the bearing 26b, and “B_{26c}” for the bearing 26c. For purposes herein, the term “axial” implies alignment with the axis A, and the term “axial loading” refers to forces that are applied parallel to this direction, and therefore perpendicular to the bearing axes B.

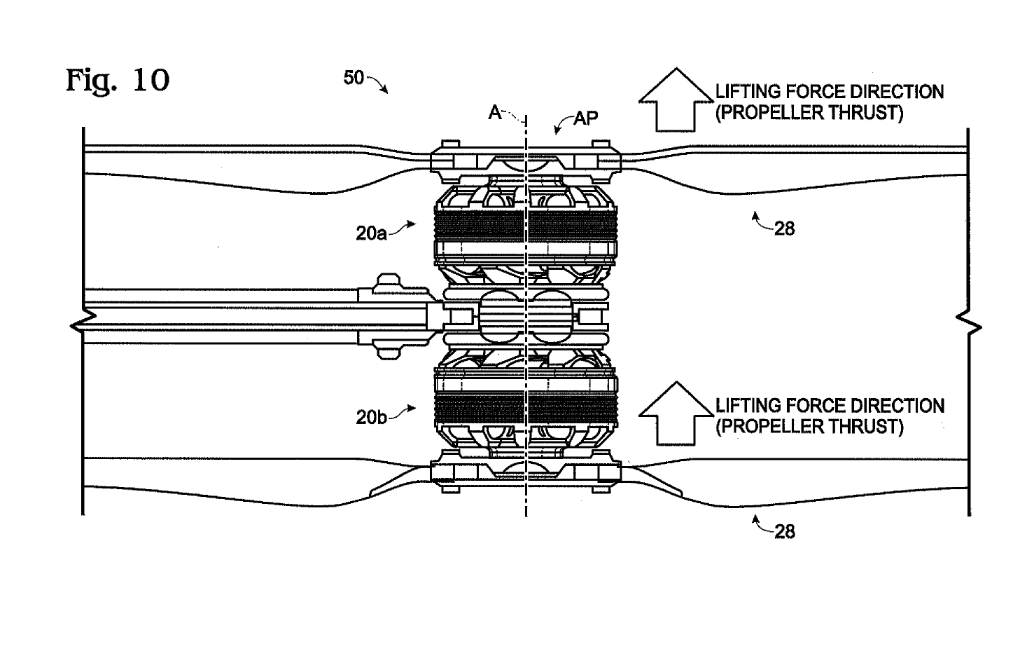

With reference to FIG. 10, two instances of the motor 20, namely 20a and 20b, are shown as they may be used in a UAS 50 according to the present invention. Only one “corner” of the UAS 50 is shown—there may be any number of corners, and typically there are four.

In each of the motors 20, one or more angled blades 28 is attached at an attachment point “AP” at the output end of the rotor. This may be arranged in any number of ways, such as by mounting the blades directly to the output end 17 of the shaft portion 22a, or mounting the blades to the top cap portion 22b, where the top cap portion is attached to the output end of the shaft portion, or mounting the blades to another portion which may be attached to either the output end 17 of the shaft portion or the cap portion. In any case, there are typically two angled blades extending radially from the shaft portion in opposite directions such as shown.

The respective axes of rotation A of the motors 20a and 20b are co-linear, and the motors are oriented so that the output end of the shaft of one of the motors extends along the common axis A in one direction whereas the output end of the shaft of the other motor extends along the common axis A in the opposite direction. The angle of the blades 28 relative to the horizontal defines an angle of attack. The objective is to develop, as a result of providing the angle of attack of the blades 28, lift forces from both motors in the same axial direction as indicated by the arrows when the rotor of each motor is turned in a fluid such as air. The lift forces are at least primarily, and are ordinarily at least 90%, axially directed.

One advantage of providing pairs of motors 20a, 20b that provide lift force in the same direction along a common axis A is to facilitate safer operation of the UAS, so that if one of the motors fails, the other motor can continue to provide lift at the same location of the UAS to avoid a complete loss of control of the UAS. However, it is not essential to provide for both motors 20a and 20b.

The desired congruence of the lift forces produced by the motors 20a and 20b may be provided either by reversing the angle of attack of the angled blades 28 on the motor 20b relative to the motor 20a, or by controlling the motor 20b so that the rotor thereof spins in the opposite direction from that of motor 20a.

In either case, the motor 20a will have an axial loading that is in the opposite direction of the axial loading on the motor 20b. So if, as is desirable for both manufacturing and performance-related reasons, the motors 20a and 20b have substantially identical construction, it is advantageous to adapt the motor 20 so that it is suitable for operation under either of these two loading circumstances.

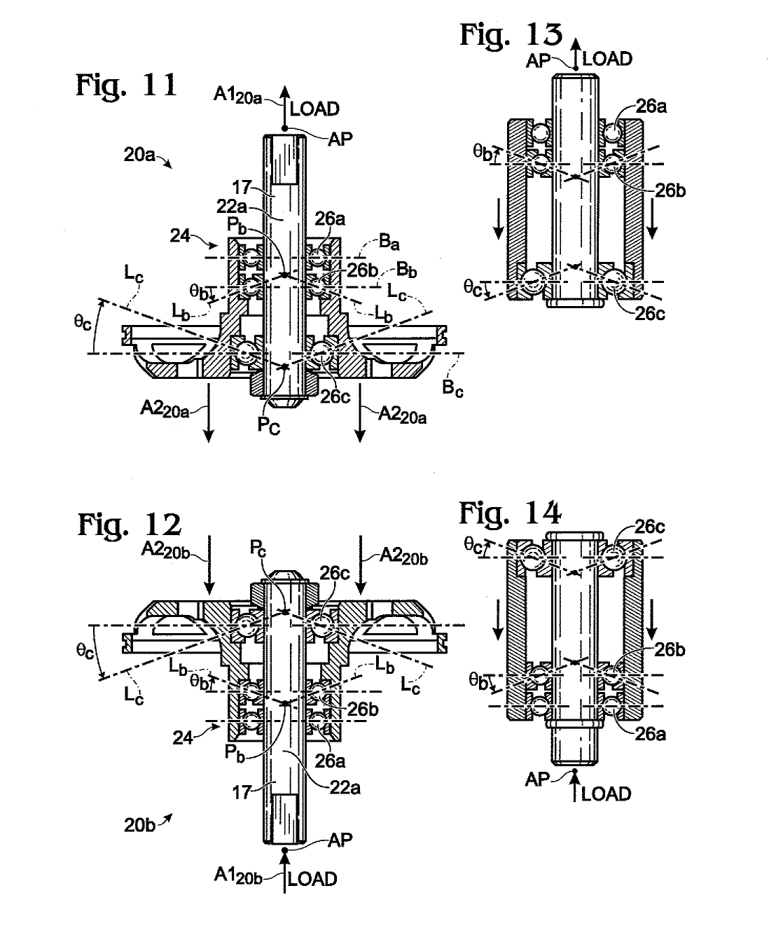

With reference to FIG. 4, looking down on the stator from above, and FIG. 9, the bearings 26a and 26b occupy space in competition with the ferritic material in the stator 24 used to enhance the magnetic fields of the coils; so it is desirable to minimize the diameters of the bearings 26a and 26b. On the other hand, with reference to FIG. 11, looking up on the stator from below, and FIG. 9, the bearing 26c is attached to the aforedescribed cap portion 24b of the stator, and therefore does not encroach into the space devoted to the ferritic material. So the bearing 26c may be allowed to have a larger diameter than the bearings 26a and 26b, and providing both bearings 26a and 26b allows for at least partially compensating for this difference, so that the total bearing area may be equal or at least more nearly equal at both ends of the shaft portion 22a.

In particular, FIGS. 3 and 9 show that respective outermost diameters D₂₆ₐ and D_{26b} of the bearings 26a and 26b may be nominally equal, whereas the corresponding outermost diameter D_{26c} of the bearing 26b may be nominally greater than either of the diameters D₂₆ₐ and D_{26b} by a significant amount, such as at least 10%, and typically at least 15%.

Turning now to FIGS. 11-14, FIGS. 11 and 12, on the one hand, and 13 and 14 on the other, illustrate two different bearing arrangements that may be used in the motor 20 according the invention. Taking the arrangement of FIGS. 11 and 12 first, and with particular reference to FIG. 11, the shaft portion 22a of the rotor 22 of the motor 20 is shown along with the stator 24, and bearings 26a, 26b, and 26c having respective bearing axes Bₐ, B_{b}, and B_{c}. The aforementioned angled blades are not shown attached to the motor, but it is to be understood that they are fitted to the rotor at an attachment point AP at the output end 17 of the shaft portion and provide an axial loading on the output end of the shaft portion of the rotor, the direction of which is indicated by arrows.

The contact angle of the bearing 26a is nominally zero because it is a radial contact bearing. Also for purposes herein, a nominal contact angle of zero may include contact angles that are less than 15 degrees.

The contact angle θ_{b} of the bearing 26b is nominally nonzero because it is an angular contact bearing; also for purposes herein, a contact angle that is nominally non-zero may include contact angles as low as 15 degrees; preferably, the contact angle is at least 30 degrees, more preferably it is 40 to 45 degrees, and it may be higher than 45 degrees.

The bearing 26b is also shown oriented in a particular direction, such that the lines of contact “L_{b}” of the bearing 26b intersect at a point “P_{b}” that is closer to the attachment point than the bearing axis B_{b}. Likewise, the contact angle θ_{c} of the bearing 26c is also nominally nonzero because it is an angular contact bearing, and the angle θ_{c} is preferably equal in magnitude to the angle θ_{b} of the bearing 26b.

The contact angles θ_{b} and θ_{c} as shown are of opposite polarity, here such that the lines of contact “L_{c}” of the bearing 26c intersect at a point “P_{c}” that is farther from the attachment PA than the bearing axis B_{c}.

FIG. 11 corresponds to the motor 20a, in which the axial load attached to the rotor at the point of attachment PA pulls on the shaft portion in the direction of the arrow “A1₂₀ₐ,” with the stator resisting in the direction of the arrows “A2₂₀ₐ;” whereas FIG. 12 corresponds to the same bearing arrangement in the motor 20b. In the motor 20b, the axial load pushes on the shaft portion in the direction of the arrow “A1_{20b},” with the stator resisting in the direction of the arrows “A2_{20b}.”

It can be appreciated by studying FIG. 11 that the axial load is resisted by the bearings 26a and 26c, but not by the bearing 26b; whereas in FIG. 12, the axial load is resisted by the bearings 26a and 26b but not by the bearing 26c.

FIGS. 13 and 14 correspond, respectively, to FIGS. 11 and 12, the only difference being that in the bearing arrangement of FIGS. 13 and 14, the polarities of the contact angles are reversed compared to the bearing arrangement of FIGS. 11 and 12. The aforedescribed conclusions are likewise reversed, i.e., in FIG. 13, the axial load is resisted by the bearings 26a and 26b, but not by the bearing 26c; whereas in FIG. 14, the axial load is resisted by the bearings 26a and 26c but not by the bearing 26b.

The present inventor has recognized this, and has recognized further that both bearing arrangements are satisfactory under both axial loading conditions. That is, in the axial loading condition represented by FIGS. 11 and 14, the load is resisted by bearings at both ends of the shaft portion 22c, and in the loading condition represented by FIGS. 12 and 13, even though the load is only resisted by bearings at one end of the shaft portion, it is the end at which the load is applied, and it is not critical in this situation to support the shaft at both ends against axial loading; and even though the bearing 26c in the loading condition represented by FIGS. 12 and 13 is no longer capable of resisting axial loads, it remains to a sufficient extent resistant to radial loads.

It may appear from the discussion so far that there is no reason the positions of the bearings 26a and 26b cannot be reversed. This is true, however, the present inventor has discovered that the seals provided in angular contact bearings are generally not as effective as those provided in radial contact bearings, and has recognized that it is particularly advantageous to maintain the positions shown, where the bearing 26a is outboard of the bearing 26b, so that the bearing 26a can act as a dust shield for the bearing 26b. This shielding effect is increased the closer the proximity between the two bearings, achieving a maximum when the two bearings are in side-by-side contact with one another. However, with reference to FIG. 3, a washer 27 is preferably provided between the bearings 26a and 26b, the washer having an outer diameter that is smaller than the inner diameter of the outer races of the two bearings, to ensure that the inner races of the two bearings bear against one another, rather than the outer races.

While the bearings described herein are ball bearings, the principles described herein can be applied to other types of bearings employing rolling bearing elements, as will be appreciated by persons of ordinary mechanical skill.

Bearings are ubiquitous in mechanical devices, and there is a well developed commercial bearing industry that supplies a wide variety of standardized or “off-the-shelf” bearings. It is contemplated that each of the three bearings 26 will typically be purchased as a separate, pre-assembled unit from a bearing manufacturer offering that bearing as a standard part, so that the bearing diameter has a nominal value which will be subject to ordinary manufacturing tolerances. However, it is not essential that any of the bearings 26 be standard parts; any one or more of them could be made to order; moreover, any one or more of their components could be provided integrally with the rotor and/or stator.

While additional bearings may be provided, this is recognized as being generally unnecessary, so that it is generally preferable to provide just one radial contact bearing and two angular contact bearings, with no additional bearings that employ rolling bearing elements, to save cost, particularly when the motor is for use in an unmanned aerial system, in which minimizing weight is also important.

While the present invention is particularly adapted for electric motors that are used to propel UAS's, it should now be understood that bearing arrangements according to the invention may be used in any motor that is subject to axial loading, and moreover that such arrangements provide particular advantages in the context of motors having space limitations at the output end of the shaft and which may be subject to axial loading in either direction.

It should also be understood that, while a specific bearing arrangement for an electric motor used for propelling an unmanned aerial system has been shown and described as preferred, variations can be made, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A bearing arrangement in an electric motor for an unmanned aerial system, the motor having a rotor establishing an axis of rotation thereof, and a stator, the rotor including a shaft having an output end that extends in a first direction along the axis of rotation and an opposite end, the bearing arrangement comprising:
a first bearing including first rolling bearing elements, a first inner race, and a first outer race, the first inner race having a corresponding inner race surface and opposed outer race surface and the first outer race having a corresponding inner race surface and opposed outer race surface, wherein the first rolling bearing elements are disposed between and bear against respective portions of the inner race surface of the first outer race and the outer race surface of the first inner race;
a second bearing including second rolling bearing elements, a second inner race, and a second outer race, the second inner race having a corresponding inner race surface and opposed outer race surface and the second outer race having a corresponding inner race surface and opposed outer race surface, wherein the second rolling bearing elements are disposed between and bear against respective portions of the inner race surface of the second outer race and the outer race surface of the second inner race; and
a third bearing including third rolling bearing elements, a third inner race, and a third outer race, the third inner race having a corresponding inner race surface and opposed outer race surface and the third outer race having a corresponding inner race surface and opposed outer race surface, wherein the third rolling bearing elements are disposed between and bear against respective portions of the inner race surface of the third outer race and the outer race surface of the third inner race,
wherein the outer race surface of the first inner race encircles and bears against a first portion of the shaft proximate the output end of the shaft and the outer race surface of the first outer race is encircled by and bears against a first portion of the stator proximate the output end of the shaft,
wherein the outer race surface of the third inner race encircles and bears against a portion of the shaft proximate the opposite end of the shaft and the outer race surface of the third outer race is encircled by and bears against a portion of the stator proximate the opposite end of the shaft,
wherein the outer race surface of the second inner race encircles and bears against a second portion of the shaft between the first and third bearings and the outer race surface of the second outer race is encircled by and bears against a second portion of the stator between the first and third bearings,
wherein the first bearing has a first contact angle and the second bearing has a second contact angle, and one of the first and second contact angles is nominally zero while the other of the first and second contact angles is nominally non-zero.

2. The bearing arrangement of claim 1, wherein the first contact angle is nominally zero and the second contact angle is nominally non-zero.

3. The bearing arrangement of claim 2, wherein the third bearing has a third contact angle that is nominally non-zero, and wherein the second and third contact angles have opposite polarities.

4. The bearing arrangement of claim 3, wherein the electric motor is brushless.

5. The bearing arrangement of claim 4, wherein the electric motor is an outrunner.

6. The bearing arrangement of claim 5, wherein at least one instance of the electric motor is included in the unmanned aerial system, and wherein a set of one or more angled blades are operably connected to the electric motor at the output end of the shaft.

7. The bearing arrangement of claim 4, wherein at least one instance of the electric motor is included in the unmanned aerial system, and wherein a set of one or more angled blades are operably connected to the electric motor at the output end of the shaft.

8. The bearing arrangement of claim 3, wherein at least one instance of the electric motor is included in the unmanned aerial system, and wherein a set of one or more angled blades are operably connected to the electric motor at the output end of the shaft.

9. The bearing arrangement of claim 2, wherein at least one instance of the electric motor is included in the unmanned aerial system, and wherein a set of one or more angled blades are operably connected to the electric motor at the output end of the shaft.

10. The bearing arrangement of claim 1, wherein at least one instance of the electric motor is included in the unmanned aerial system, and wherein a set of one or more angled blades are operably connected to the electric motor at the output end of the shaft.

11. The bearing arrangement of claim 10, wherein at least two instances of the electric motor are included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

12. The bearing arrangement of claim 9, wherein at least two instances of the electric motor are included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

13. The bearing arrangement of claim 8, wherein at least two instances of the electric motor are included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

14. The bearing arrangement of claim 7, wherein at least two instances of the electric motor are included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

15. The bearing arrangement of claim 6, wherein at least two instances of the electric motor are included in the unmanned aerial system, wherein respective sets of one or more propeller blades are operably connected to the respective electric motors at the respective output ends of the respective shafts, and wherein the output of the shaft of one of the at least two instances of the electric motor extends in the first direction and the output end of the shaft of another of the at least two instances of the electric motor extends along the axis of rotation in a second direction that is opposite the first direction.

16. The bearing arrangement of claim 5, including no bearings that have rolling bearing elements other than the first, second, and third bearings.

17. The bearing arrangement of claim 4, including no bearings that have rolling bearing elements other than the first, second, and third bearings.

18. The bearing arrangement of claim 3, including no bearings that have rolling bearing elements other than the first, second, and third bearings.

19. The bearing arrangement of claim 2, including no bearings that have rolling bearing elements other than the first, second, and third bearings.

20. The bearing arrangement of claim 1, including no bearings that have rolling bearing elements other than the first, second, and third bearings.
